(19) United States
(12) Patent Application Publication
(10) Pub. No.: US 2016/0185639 A1
(43) Pub. Date: Jun. 30, 2016

(54) METHOD AND APPARATUS FOR OPTIMIZATION OF A CONVENTIONAL WASTE WATER TREATMENT PLANT

(71) Applicant: ClearCove Systems, Inc., Rochester, NY (US)

(72) Inventor: Terry W. Wright, Rochester, NY (US)

(21) Appl. No.: 14/587,635

(22) Filed: Dec. 31, 2014

(51) Int. Cl. C02F 11/16

(52) U.S. Cl. CPC C02F 11/16

(57) ABSTRACT

A system for settling solids in a waste water treatment facility, comprising an elongate tank for receiving a waste water influent and discharging a waste water effluent, a first sludge collector disposed in a first chamber in the tank, a second sludge collector disposed in a second chamber in the tank, a first sludge hopper formed in the bottom of the tank adjacent the first sludge collector, a second sludge hopper formed in the bottom of the tank adjacent the second sludge collector, and a plate disposed between the first and second sludge collectors and extending upwards from the bottom between the first and second sludge hoppers to define the first and second chambers. Preferably, a weir is formed in the upper edge of the plate.

### TECHNICAL FIELD

The present application relates to systems for processing waste water; more particularly, to such systems for handling biologically digestible materials in sewage; and most particularly to methods and apparatus for improving the efficiency of BOD and solids removal in a conventional constant-flow settling tank using flights and chains to remove settled sludge.

### BACKGROUND

The primary historical objective of waste water treatment operations has been to neutralize and otherwise render sewage effluence in compliance with regulatory limits based on environmental and health standards. An important and growing objective of modern waste water treatments is the generation of energy from biologically-digestible organic materials present in the waste water. To achieve this objective, during the treatment of waste water influent streams containing biologically-digestible materials, as part of selectively classifying and separating grits, solids, hair and fibers, particulates, and solvated materials, it is particularly desirable to separate the digestible materials in the influent stream from non-digestible materials such that digestion of the digestible materials can be optimized.

Conventional rectangular settling tanks used in waste water primary treatment typically operate with a continuous flow of influent, relying on the hydrostatic retention time of the fluid in traversing the length of the tank to settle solids prior to such fluid exiting the tank. Typically, a conventional settling tank employs a system of moving flights and chains to scrape settled solids from the bottom of the tank and drag the solids to an outlet hopper where they are collected for further processing, e.g., for anaerobic digestion or landfilling. The choice and economics of such further treatment are directly related to the amount of digestible materials not recovered by the flights and chains and remaining in suspension or solution when the influent becomes effluent from the tank. It has been shown experimentally that a modest increase in the percent recovery of digestible solids can yield sufficient methane energy that upon such digestion of the solids the overall operation of a treatment plant can pay for itself.

### SUMMARY

Briefly described, a system in accordance with the present application comprises an improved method and apparatus for separating biologically digestible materials from an influent sewage stream. The method and apparatus increase the efficiency of settling by reducing turbulence in the tank, especially near the prior art sludge hopper outlet.

In a conventional settling tank installation, a system of a baffle adjacent the influent inlet plus moving flights and chains and move settled sludge as just described. In a typical rectangular clarifier a first set of flights and chains, defining a first collector, operates in a first direction longitudinally of the tank, and a second set of flights and chains defining a second collector operates transversely of the tank adjacent to the tank influent inlet. Because of counterflows and turbulence set up in the tank by this arrangement, a significant percentage of digestible solids remains in suspension and is not accumulated with the sludge.

In the present application, a second hopper is added such that one hopper is fed by the first collector and the other hopper is fed by the second collector.

In a first embodiment the baffle is replaced by a plate extending upwards from the bottom of the tank between the first and second collectors, creating an internal weir requiring the liquid to rise up and over the weir.

In a second embodiment, the prior art baffle is left undisturbed but the internal weir is added, creating a labyrinthine flow path for the influent to reach the first hopper and first collector.

In a third embodiment, the baffle is replaced by a full-fitting perforated wall disposed between the first and second collectors, the perforations being positioned well away from the bottom of the tank.

In any of these embodiments, the influent flow may be split into two opposing streams as it enters the tank to slow the forward velocity of the influent.

### BRIEF DESCRIPTION OF THE DRAWINGS

The present application will now be described, by way of example, with reference to the accompanying drawings, in which:

FIGS. 1A, 1B, and 1C are schematic drawings of a prior art settling tank system in a water treatment plant;

FIG. 2 is a schematic drawing of an elevational cross-sectional view of a first embodiment of an improved settling tank system;

FIG. 3 is a schematic drawing of an elevational cross-sectional view of a second embodiment of an improved settling tank system;

FIG. 4 is a schematic drawing of an elevational cross-sectional view of a third embodiment of an improved settling tank system; and

FIG. 5 is a schematic drawing of a plan view of an improved settling tank system.

Corresponding reference characters indicate corresponding parts throughout the several views. The exemplifications set out herein illustrate currently preferred embodiments, and such exemplifications are not to be construed as limiting the scope of the invention in any manner.

### DESCRIPTION OF THE PREFERRED EMBODIMENTS

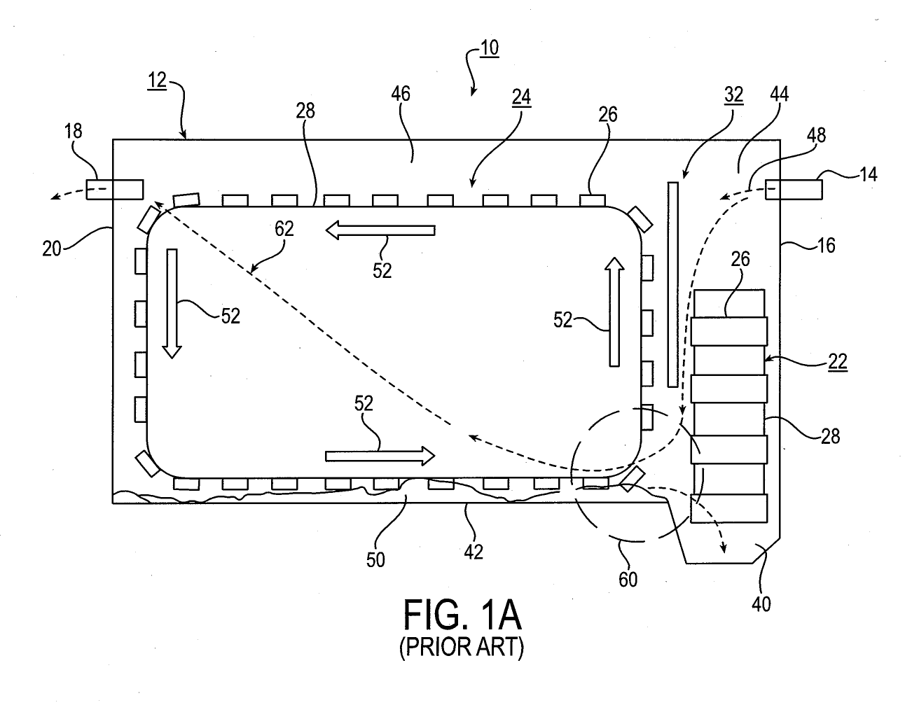

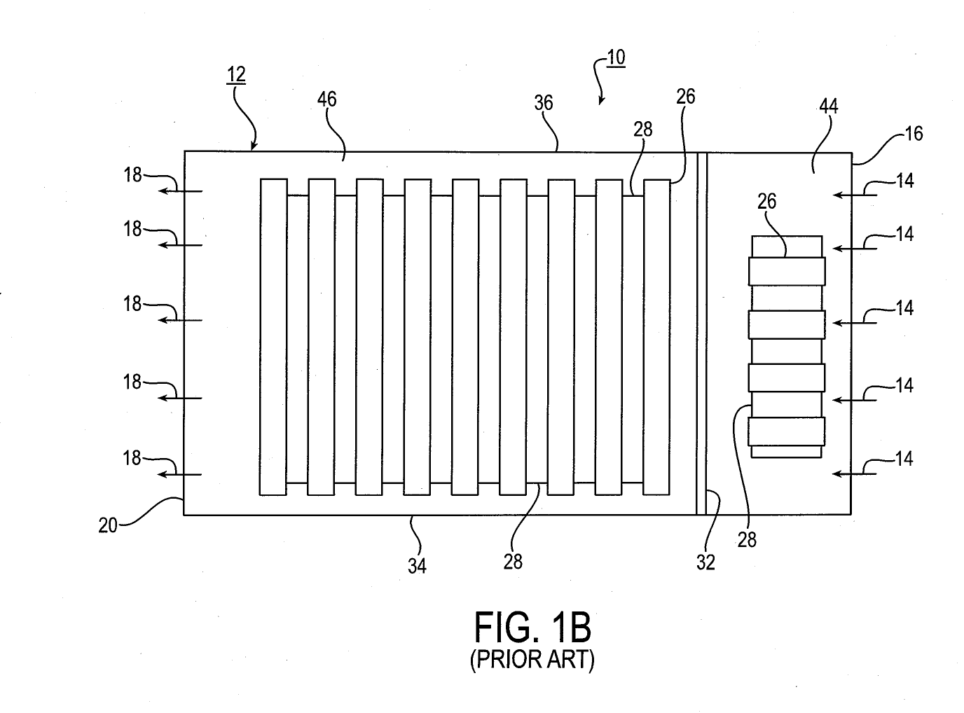

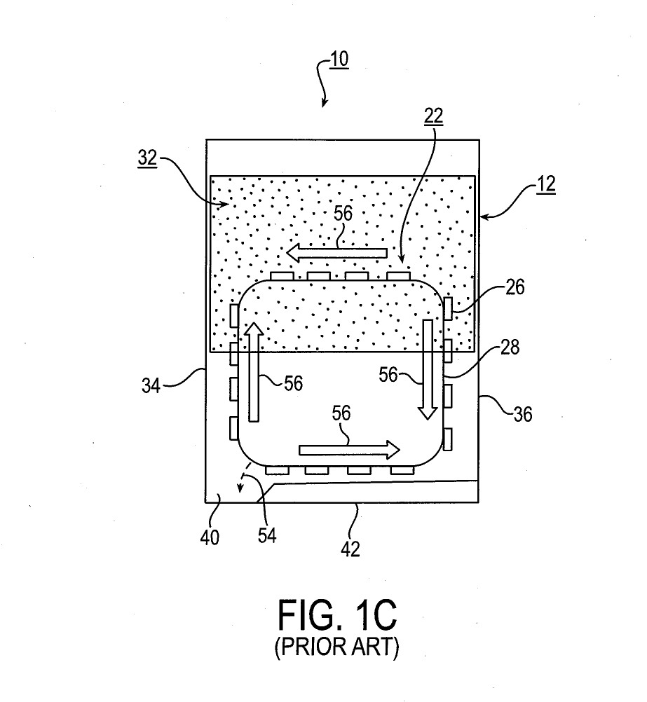

Referring now to FIGS. 1A-1C, a typical sludge settling system 10 comprises a generally rectangular tank 12, which may be open or closed at the top, having an influent inlet including one or more inlet openings 14 through a first tank wall 16 and one or more effluent openings 18 through an opposite tank wall 20. The effluent opening 18 may be an effluent trough with a weir, a pipe, or any other means for liquid to exit the tank.

Disposed within tank 12 are first and second sludge collectors 22,24, each comprising a driven assembly of flights in the form of transverse slats 26 attached to a continuous, flexible element 28 such as, for example, a pair of endless metal or polycarbonate chains.

Typically, first collector 22 is oriented transversely of tank 12 and adjacent to influent opening(s) 14, and second collector 24 is oriented longitudinally of tank 12. Typically, slats 26 of first collector 22 are relatively short, whereas the slats 26 of second collector 24 extend substantially the full width of tank 12. Typically, first collector 22 scrapes the settled sludge, mostly grits and dense solids in this portion of the tank, to a hopper 40 formed in the bottom 42 of tank 12, as shown in FIG. 1A. Typically, the bottom 42 has a slight slope to facilitate movement of the settled sludge under the influence of gravity.

A transverse baffle 32 is disposed between third and fourth tank walls 34,36 and is off-spaced from tank bottom 42. Baffle 32 divides the interior of tank 12 into first and second functional chambers 44,46, respectively.

In operation, influent 48 enters first chamber 44 via openings 14 near the top of tank 12. The baffle 32 extends above the upper most level of the fluid in tank 12. Influent 48 flows down along baffle 32 toward sludge hopper 40, then passes under baffle 32 into second chamber 46. In a typical tank 12, the length of the tank is many times longer than it is deep. The tank is sized in relation to the influent flow rate, such that the forward velocity of the fluid is 0.009 feet per second. This results in the settling of the solids to the bottom 42 of the tank 12 to form a sludge 50 as the fluid moves from the influent side of the tank 12 to the effluent side of the tank 12. Sludge 50 that settles to the bottom of second chamber 46 is swept along toward hopper 40 by the slats 26 on second collector 24, which is slowly rotated in second direction 52. The overall intent of this arrangement is to have sludge 50 deposited under first collector 22 which rotates in first direction 56, which then sweeps both sludge 50 and sludge 54 into hopper 40.

A serious problem arises, however, with this arrangement that serves to reduce the efficiency of digestible solids recovery. Because a majority of the second portion of influent 48 flows under baffle 32 to enter second chamber 46, this influent flows counter to direction 52 in which sludge 50 is being moved toward hopper 40. In the region 60, such counterflow creates turbulence which causes some of the lower-density settled digestible solids in sludge 50 to be entrained undesirably in the overall flow 62 being directed to effluent outlet 18. These lower-density materials are believed to have energy content that is high relative to the denser, faster-settling solids and thus these materials are especially desirable for recovery.

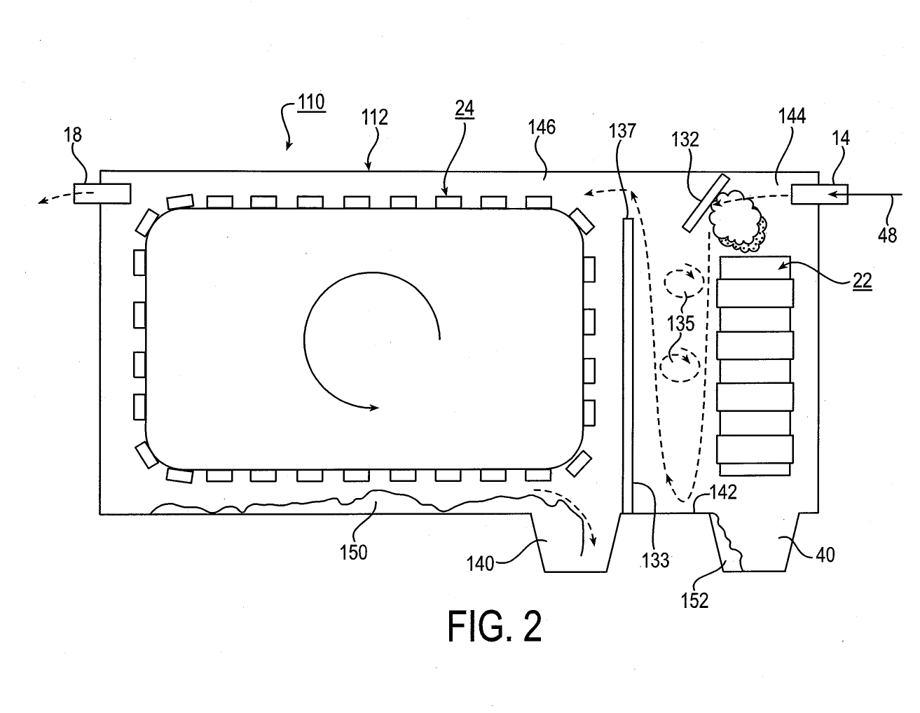

Referring now to FIG. 2, in a first embodiment 110 of an improved sludge settling system, tank 12 is extended to form improved tank 112, creating additional space between first and second collectors 22,24 and permitting addition of a second hopper 140 in bottom 42 beneath second collector 24. In another embodiment, the flight and chains 24 are shortened to create space for the addition of a second hopper 140 in bottom 42 beneath second collector 24. Each of first and second collectors 22,24 are provided with a separate, dedicated hopper, and that the two hoppers 40,140 be physically separated by a vertical plate to eliminate the source of counterflow and turbulence adjacent hopper 40 in conventional systems. Baffle 32 is replaced with an angled deflection plate 132, and a plate 133 between first and second collectors 22,24 that extends upward from bottom 142 of tank 112. In one embodiment (not shown), the angled deflection plate is placed orthogonal to the direction of the influent flow.

In operation, influent 48 enters first chamber 144, passes above first collector 22, is deflected downward by angled deflector 132, rebounds from bottom 142, and passes upward along plate 133, creating turbulence 135. Larger and heavier solids settle to the bottom of first chamber 144 and are advanced by collector 22 to first hopper 40 as sludge 152. Influent 48 then passes over internal weir 137 into second chamber 146 where settling of smaller and lower-density solids occurs. Because the source of turbulence near first hopper 40 has been eliminated, a substantially higher percentage of digestible solids is retrieved in sludge 150 and 152 combined.

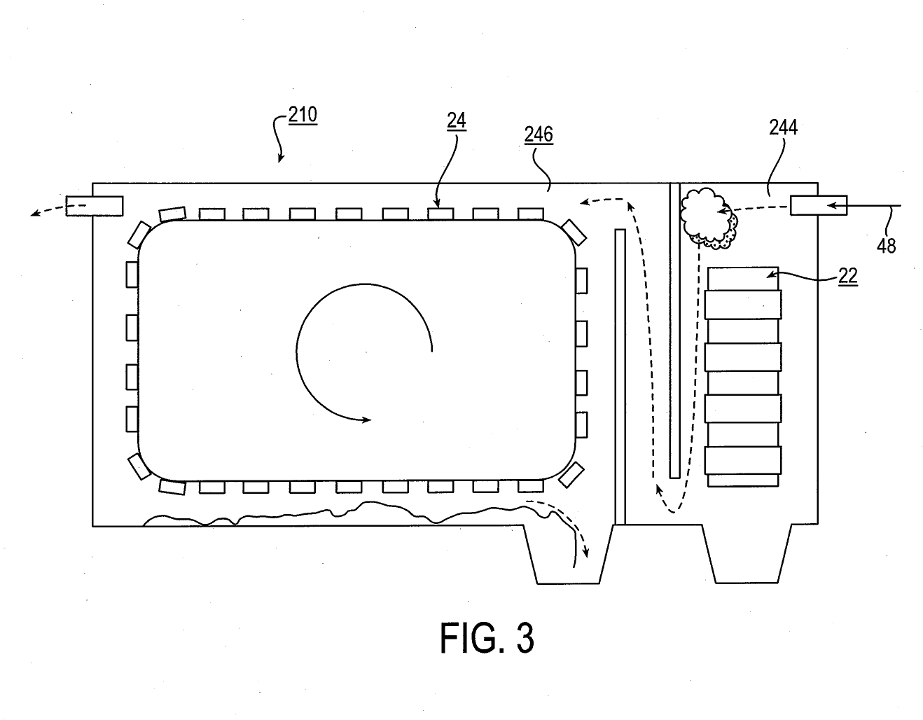

Referring now to FIG. 3, in a second embodiment 210 of an improved sludge settling system, as in first embodiment 110 of FIG. 2 an internal plate 133 and weir 137 are included. In addition, angled deflector 132 is replace by an inverted plate 233 and weir 237, reducing the linear velocity of influent by creating a labyrinthine flow path 280 for influent in passing from chamber 244 to chamber 246.

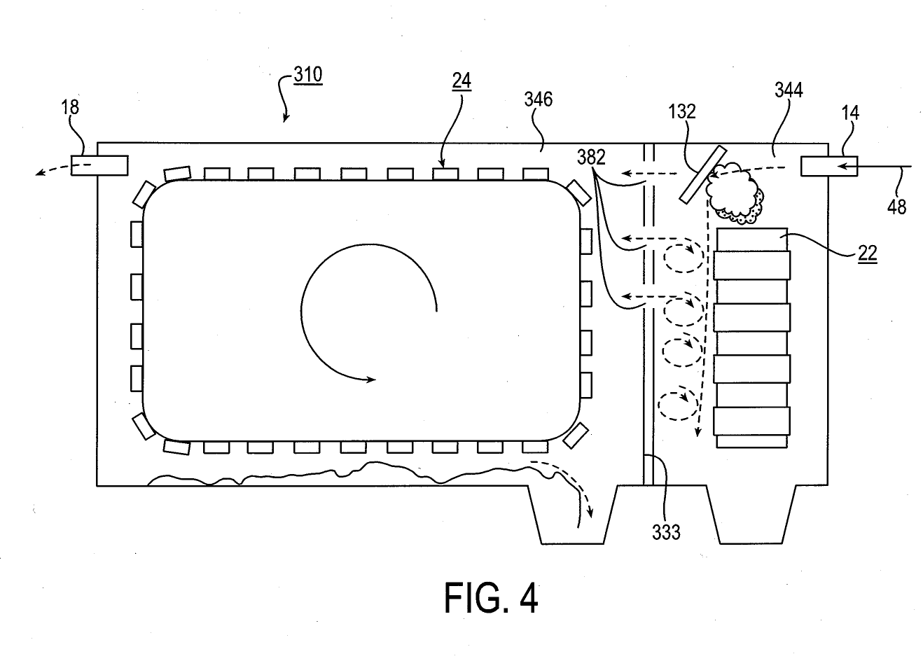

Referring now to FIG. 4, a third embodiment 310 of an improved sludge settling system is similar to first embodiment 110. Angled deflector 132 is retained, but plate 133 and weir 137 are replaced by a full-fitting tank divider plate 333 having a plurality of openings 382. Because influent flow from chamber 344 into chamber 346 is divided among the plurality of openings 382, the velocity through each opening is relatively low, thereby creating a more nearly stagnant environment for settling of solids in chamber 346.

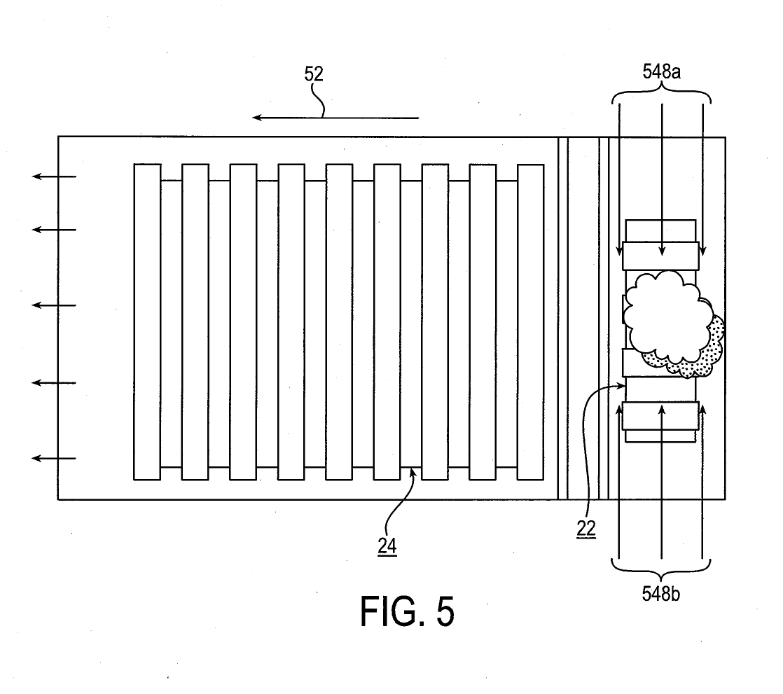

Referring now to FIG. 5, in any of the above-described embodiments, the influent may be split into two opposing streams 548a,548b to reduce the net velocity of the influent entering the tank.

While the application has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for settling solids in a waste water treatment facility, comprising:
a) an elongate tank for receiving a waste water influent and discharging a waste water effluent;
b) a first sludge collector disposed in a first chamber in said tank;
c) a second sludge collector disposed in a second chamber in said tank;
d) a first sludge hopper formed in a bottom of said tank adjacent said first sludge collector;
e) a second sludge hopper formed in said bottom of said tank adjacent said second sludge collector; and
f) a plate disposed between said first and second sludge collectors and extending upwards from said bottom between said first and second sludge hoppers.

2. A system in accordance with claim 1 further comprising a tank inlet for said waste water influent to said first chamber and a tank outlet for said waste water effluent from said second chamber.

3. A system in accordance with claim 2 further comprising at least one weir formed in an upper edge of said plate.

4. A system in accordance with claim 2 further comprising at least one opening in said plate.

5. A system in accordance with claim 1 wherein said first sludge collector comprises a plurality of first flights attached to at least one first flexible element.

6. A system in accordance with claim 5 wherein said first flights are oriented longitudinally of said tank.

7. A system in accordance with claim 5 wherein said at least one first flexible element is formed in an endless loop and is disposed and drivable in a direction such that said first flights are moved along said bottom toward said first sludge hopper.

8. A system in accordance with claim 5 wherein said first flexible element comprises a chain.

9. A system in accordance with claim 1 wherein said second sludge collector comprises a plurality of second flights attached to at least one second flexible element.

10. A system in accordance with claim 9 wherein said second flights are oriented transversely of said tank.

11. A system in accordance with claim 9 wherein said at least one second flexible element is formed in an endless loop and is disposed and drivable in a direction such that said second flights are moved along said bottom toward said second sludge hopper.

12. A system in accordance with claim 9 wherein said second flexible element comprises a chain.

13. A system in accordance with claim 2 further comprising an angled deflector cooperative with said tank inlet to redirect said waste water influent.

14. A system in accordance with claim 2 further comprising a vertical baffle disposed between said plate and said first sludge collector.

15. A system in accordance with claim 2 wherein said tank inlet is a first tank inlet, and further comprising a second tank inlet oriented in opposition to said first tank inlet.
